(19) United States
(12) Patent Application Publication
(10) Pub. No.: US 2021/0224435 A1
(43) Pub. Date: Jul. 22, 2021

(54) METHOD FOR DESIGNING NEW PURLEY CPU HEAT SINK

(71) Applicant: ZHENGZHOU YUNHAI INFORMATION TECHNOLOGY CO., LTD., Zhengzhou, Henan (CN)

(72) Inventor: Guangzhi LIU, Zhengzhou, Henan (CN)

(73) Assignee: ZHENGZHOU YUNHAI INFORMATION TECHNOLOGY CO., LTD., Zhengzhou, Henan (CN)

(21) Appl. No.: 16/097,177

(22) PCT Filed: Nov. 30, 2017
(86) PCT No.: PCT/CN2017/113870

§ 371 Date: Oct. 26, 2018

(30) Foreign Application Priority Data
Aug. 18, 2017 (CN) 201710710756.9

(51) Int. Cl. G06F 30/20

(52) U.S. Cl. CPC G06F 30/20; G06F 2111/20

(57) ABSTRACT

A method for designing a new Purley CPU heat sink is provided, which includes: obtaining a ventilation volume and obtaining a thermal resistance Rca of a heat sink; selecting a CPU model, obtaining a power consumption value and obtaining a maximum allowable surface temperature value Tcmax of the CPU model; obtaining a product of the thermal resistance Rca of the heat sink and the power consumption value as a CPU surface temperature value Tc; and comparing the CPU surface temperature value Tc with the maximum allowable surface temperature value Tcmax of the CPU model, determining that the heat sink supports the CPU model if the CPU surface temperature value Tc is lower than or equal to the maximum allowable surface temperature value Tcmax of the CPU model; otherwise, determining that the heat sink does not support the CPU model.

This application claims the priority to Chinese Patent Application No. 201710710756.9 titled “METHOD FOR DESIGNING NEW PURLEY CPU HEAT SINK”, filed with the Chinese Patent Office on Aug. 18, 2017, which is incorporated herein by reference in its entirety.

### FIELD

The present disclosure relates to the technical field of server internal cooling and heat dissipation, in particular to a method for designing a new Purley CPU heat sink.

### BACKGROUND

With the development of CPU technologies, the function and integration density of CPUs are greatly improved, while the CPU power consumption due to heat generation is also gradually increased. In the computer industry, conventional CUPs, for example, the latest version of CPU on the Purley platform, are widely used. The maximum power consumption of the latest version of Intel Purley CPU has increased to a level above 250 W. Considering the wide application of Intel Purley CPU, the design of the Purley CPU heat sink is becoming more and more important. Since the Purley CPU vary greatly in power consumption due to heat generation, it is difficult to determine the type of CPU supported by the designed heat sink. In the conventional technology, there is no method for evaluating whether a newly designed heat sink supports a certain type of CPU and meets the heat dissipation requirements of the CPU.

### SUMMARY

The object of the present disclosure is to solve the above problem in the conventional technology, and to provide a method for designing a new Purley CPU heat sink. According to the present disclosure, a CPU power consumption level that can be supported by the designed heat sink can be evaluated by analysis in advance, and whether the designed heat sink meets the heat dissipation performances of Purley CPUs of different models can be evaluated quickly and effectively at a low design cost.

The technical solution of the present disclosure for solving the technical problem is as follows.

A method for designing a new Purley CPU heat sink is provided, which includes the following steps:

obtaining a ventilation volume in a scene, and obtaining a thermal resistance Rca of a heat sink by looking up a table;

selecting a CPU model, obtaining a power consumption value by looking up a table, and obtaining a maximum allowable surface temperature value Tcmax (or Tcasemax) of the CPU model by looking up a table;

obtaining a product of the thermal resistance Rca of the heat sink and the power consumption value as a CPU surface temperature value Tc in the scene; and

comparing the CPU surface temperature value Tc with the maximum allowable surface temperature value Tcmax of the CPU model, determining that the heat sink supports the CPU model if the CPU surface temperature value Tc is lower than or equal to the maximum allowable surface temperature value Tcmax of the CPU model, and determining that the heat sink does not support the CPU model and repeating previous steps to reselect a CPU model with a lower case temperature if the CPU surface temperature value Tc is greater than the maximum allowable surface temperature value Tcmax of the CPU model.

The thermal resistance Rca of the heat sink may be obtained by heat dissipation simulation through following steps: building a detailed computer model by using heat dissipation simulation software, and obtaining the thermal resistance Rca by using a temperature simulation function of the detailed computer model.

The thermal resistance Rca of the heat sink may be obtained by measurement through following steps: establishing a physical scene by using a wind tunnel measuring device; in the physical scene, arranging a CPU or a heat block under the heat sink, monitoring a temperature change of the heat sink while controlling power consumption of the CPU or the heat block, and obtaining the thermal resistance Rca by calculation; and performing a wind tunnel analysis on a structure of the heat sink, and determining a range of CPU power consumption due to heat generation supported by the heat sink in conjunction with a ventilation volume of the physical scene.

The selecting the CPU model may include: selecting different Purley CPU models; performing comparison on maximum allowable surface temperature values Tcmaxs of the Purley CPU models; classifying the Purley CPU models into a supportable category and a unsupportable category based on the maximum allowable surface temperature values Tcmax of the Purley CPU models; and determining a Purley CUP model in the supportable category as an applicable CPU model. Since the CPU model supported by the heat sink varies according to the design structure of the heat sink, the process of selecting and evaluating the CPU model can be greatly simplified with the method, such that the time required for selection can be saved and the selection efficiency can be improved.

The present disclosure has the following advantages.

1. According to the present disclosure, the CPU power consumption level that can be supported by the designed heat sink can be evaluated in advance, and whether the designed heat sink meets the heat dissipation performances of Purley CPUs of different models can be evaluated quickly and effectively at a low design cost.

2. Different Purley CPU models are selected, comparison is performed on the maximum allowable surface temperature values Tcmax of the Purley CPU models, the Purley CPU models are classified into the supportable category and the unsupportable category based the maximum allowable surface temperature values Tcmax of the Purley CPU models, and a Purley CPU model in the supportable category is determined as a applicable CPU model. Since the CPU model supported by the heat sink varies according to the design structure of the heat sink, the process of selecting and evaluating the CPU model can be greatly simplified with the method, such that the time required for selection can be saved and the selection efficiency can be improved.

### BRIEF DESCRIPTION OF THE DRAWINGS

FIG. 1 is a flow chart of a first embodiment of the present disclosure.

### DETAIL DESCRIPTION OF EMBODIMENTS

For a better understanding of the present disclosure, embodiments of the present disclosure are described in detail hereinafter with reference to the accompanying drawing.

### First Embodiment

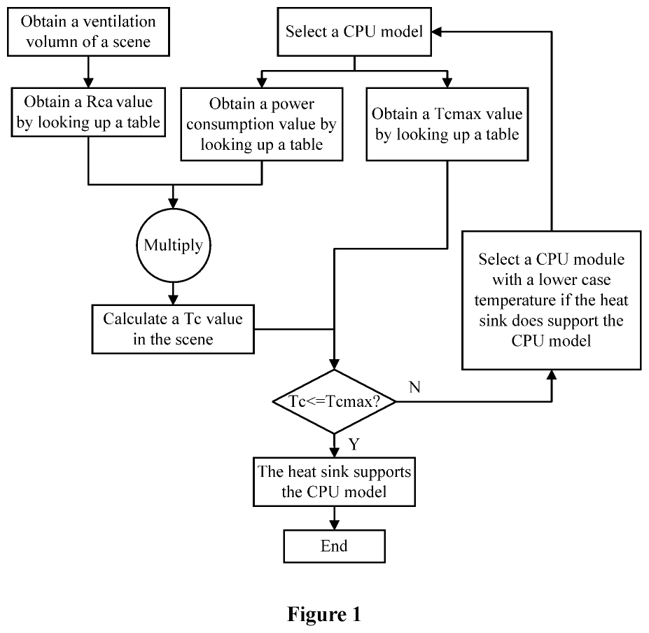

Reference is made to FIG. 1. A method for designing a new Purley CPU heat sink includes the following steps:

obtaining a ventilation volume in a scene, and obtaining a thermal resistance Rca of a heat sink by looking up a table;

selecting a CPU model, obtaining a power consumption value by looking up a table, and obtaining a maximum allowable surface temperature value Tcmax (or Tcasemax) of the CPU model by looking up a table;

obtaining a product of the thermal resistance Rca of the heat sink and the power consumption value as a CPU surface temperature value Tc in the scene; and

comparing the CPU surface temperature value Tc with the maximum allowable surface temperature value Tcmax of the CPU model, determining that the heat sink supports the CPU model if the CPU surface temperature value Tc is lower than or equal to the maximum allowable surface temperature value Tcmax of the CPU model, and determining that the heat sink does not support the CPU model and repeating the previous steps to reselect a CPU model with a lower case temperature if the CPU surface temperature value Tc is greater than the maximum allowable surface temperature value Tcmax of the CPU model.

The thermal resistance Rca of the heat sink is obtained by heat dissipation simulation. A detailed computer model is built by using heat dissipation simulation software, and the thermal resistance Rca is obtained by using a temperature simulation function of the detailed computer model.

The CPU model is selected with the following method. Different Purley CPU models are selected, comparison is performed on maximum allowable surface temperature values Tcmaxs of the Purley CPU models, the Purley CPU models are classified into a supportable category and a unsupportable category based on the maximum allowable surface temperature values Tcmax of the Purley CPU models, and a Purley CUP model in the supportable category is determined as an applicable CPU model. Since the CPU model supported by the heat sink varies according to the design structure of the heat sink, the process of selecting and evaluating the CPU model can be greatly simplified with the method, such that the time required for selection can be saved and the selection efficiency can be improved.

### Second Embodiment

The thermal resistance Rca of the heat sink is obtained by measurement. A physical scene is established by using a wind tunnel measuring device. In the physical scene, a CPU or a heat block is arranged under the heat sink, a temperature change of the heat sink is monitored while power consumption of the CPU or the heat block is controlled, and the thermal resistance Rca is obtained by calculation. A wind tunnel analysis is performed on a structure of the heat sink, and a range of CPU power consumption due to heat generation supported by the heat sink is determined in conjunction with a ventilation volume of the physical scene. One can refer to the first embodiment of other aspects, which is not repeated in this embodiment.

In the present disclosure, tests are performed on a copper heat sink structure. The following Table 1 is obtained by wind tunnel analysis in different ventilation volume scenes according to the above steps. The heat resistance R_{ca} of the heat sink is obtained by heat dissipation simulation or actual measurement, and the maximum power consumption due to heat generation and the model of the supportable CPU is obtained by reversing the flow chart.

TABLE 1

| CFM | Tc(° C.) | Ta | ΔTca | W | Rca(° C./W) |
|---|---|---|---|---|---|
| 5 | 82.00 | 22.90 | 59.10 | 100.00 | 0.5910 |
| 10 | 81.50 | 22.70 | 58.80 | 165.00 | 0.3564 |
| 15 | 70.30 | 22.80 | 47.50 | 165.00 | 0.2879 |
| 20 | 59.50 | 22.38 | 37.12 | 165.00 | 0.2250 |
| 25 | 55.60 | 22.70 | 32.90 | 165.00 | 0.1994 |
| 30 | 53.00 | 23.58 | 29.42 | 165.00 | 0.1783 |
| 35 | 51.40 | 24.08 | 27.32 | 165.00 | 0.1656 |
| 40 | 50.90 | 24.43 | 26.47 | 165.00 | 0.1604 |

In Table 1, Tc represents a CPU surface temperature value, which may also be represented by Tcase; Tcmax represents a maximum allowable surface temperature of the CPU, which may also be represented by Tcasemax; CFM represents a ventilation volume; Ta represents an ambient temperature during the test; ΔTca represents a value of (Tc−Ta), which is a difference between the CPU surface temperature and the ambient temperature; W is a heat generation amount; Rca is a thermal resistance, which is a parameter characterizing a heat dissipation capability of the heat sink, where a greater thermal resistance corresponds to lower heat dissipation capability, and a smaller thermal resistance corresponds to higher heat dissipation capability. It can be seen from the above data that, whether the designed heat sink meets the heat dissipation performance of a certain Purley CPU model can be effectively evaluated with the method in a time-efficient and labor-saving manner at a lower cost, as compared with the conventional technology.

The embodiments of the present disclosure are described above with reference to the accompanying drawings, but are not intended to limit the scope of the present disclosure. Based on the technical solution of the present disclosure, various modifications or variants made by those skilled in the art without any creative work are within the scope of the present disclosure.

1. A method for designing a new Purley CPU heat sink, comprising following steps:
obtaining a ventilation volume in a scene, and obtaining a thermal resistance Rca of a heat sink by looking up a table;
selecting a CPU model, obtaining a power consumption value by looking up a table, and obtaining a maximum allowable surface temperature value Tcmax of the CPU model by looking up a table;
obtaining a product of the thermal resistance Rca of the heat sink and the power consumption value as a CPU surface temperature value Tc in the scene; and
comparing the CPU surface temperature value Tc with the maximum allowable surface temperature value Tcmax of the CPU model, determining that the heat sink supports the CPU model if the CPU surface temperature value Tc is lower than or equal to the maximum allowable surface temperature value Tcmax of the CPU model, and determining that the heat sink does not support the CPU model and repeating previous steps to reselect a CPU model with a lower case temperature if the CPU surface temperature value Tc is greater than the maximum allowable surface temperature value Tcmax of the CPU model.

2. The method for designing a new Purley CPU heat sink according to claim 1, wherein the thermal resistance Rca of the heat sink is obtained by heat dissipation simulation through following steps:
building a detailed computer model by using heat dissipation simulation software, and
obtaining the thermal resistance Rca by using a temperature simulation function of the detailed computer model.

3. The method for designing a new Purley CPU heat sink according to claim 1, wherein the thermal resistance Rca of the heat sink is obtained by measurement through following steps:
establishing a physical scene by using a wind tunnel measuring device,
in the physical scene, arranging a CPU or a heat block under the heat sink, monitoring a temperature change of the heat sink while controlling power consumption of the CPU or the heat block, and obtaining the thermal resistance Rca by calculation, and
performing a wind tunnel analysis on a structure of the heat sink, and determining a range of CPU power consumption due to heat generation supported by the heat sink in conjunction with a ventilation volume of the physical scene.

4. The method for designing a new Purley CPU heat sink according to claim 1, wherein the selecting the CPU model comprises:
selecting different Purley CPU models;
performing comparison on maximum allowable surface temperature values Tcmaxs of the Purley CPU models;
classifying the Purley CPU models into a supportable category and a unsupportable category based on the maximum allowable surface temperature values Tcmax of the Purley CPU models; and
determining a Purley CUP model in the supportable category as an applicable CPU model.
